(19) United States
(12) Patent Application Publication
(10) Pub. No.: US 2006/0256500 A1
(43) Pub. Date: Nov. 16, 2006

(54) Electrolytic solution for electrochemical element, method of searching for the same, method of producing the same, and electrochemical element

(75) Inventors: Hiroyuki Maeshima, Kobe-shi (JP); Yasuyuki Ito, Neyagawa-shi (JP); Koji Fujioka, Kyoto-shi (JP); Takao Mukai, Kyoto-shi (JP)

Correspondence Address: STEPTOE & JOHNSON LLP, 1330 CONNECTICUT AVE., NW, WASHINGTON, DC, 20036, US

(73) Assignees: Matsushita Electric Industrial Co., Ltd., Osaka (JP); Sanyo Chemical Industries, Ltd., Kyoto-shi (JP)

(21) Appl. No.: 10/558,737

(22) PCT Filed: Jun. 7, 2004
(86) PCT No.: PCT/JP04/08263

§ 371 Date: Dec. 1, 2005

(30) Foreign Application Priority Data
Jun. 9, 2003 (JP) 2003-163136

(51) Int. Cl. H01G 2/00

(52) U.S. Cl. 361/272

(57) ABSTRACT

An electrolytic solution for electrochemical elements which comprises an anion ingredient having one or more fluorine atoms and a cation ingredient which is imidazolium or an imidazolium derivative each having one or more hydrogen atoms, and which has at least five fluorine atom/hydrogen atom pairs in each of which the distance between the fluorine atom of the anion ingredient and the hydrogen atom of the cation ingredient is 2.7 Å or shorter. For example, the ionic association compound (I) shown below has been formed in the solution. This electrolytic imidazolium solution shows a higher withstand voltage than conventional electrolytic solutions containing 1,3,4,5-tetramethylimidazolium.

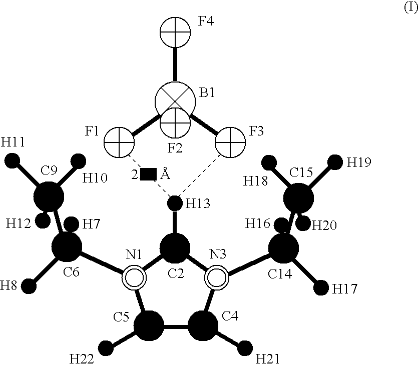

### TECHNICAL FIELD

The present invention relates to an electrolyte for electrochemical elements to be used for an electrochemical element such as an electric double layer capacitor, a method of searching for the same, a method of producing the same, and an electrochemical element using the same.

### BACKGROUND ART

Among conventional electrolytes for electrochemical elements is, for example, an electrolyte containing an imidazoline compound disclosed in Japanese Patent No.3130228. This electrolyte exhibits a high withstand voltage and a low electrolyte resistance, and accordingly is used in various electrochemical elements. A higher withstand voltage in an electrolyte to be used for an electrochemical element means that a larger amount of energy can be stored, and a smaller electrolyte resistance means that a more efficient energy storage and a more efficient energy supply can be performed. An electrolyte containing 1,3,4,5-tetramethylimidazolium, as one among other imidazoline compounds, exhibits a high withstand voltage and hence is useful.

In these years, however, desired is an electrolyte to exhibit a higher withstand voltage than the electrolyte containing 1,3,4,5-tetramethylimidazolium.

In conventional procedures having hitherto been adopted, the development of an electrolyte is made in such a way that first an electrolyte is prepared, and then the withstand voltage thereof is measured to evaluate the electrolyte; however, it is difficult to predict as to which electrolyte will exhibit a high withstand voltage, and consequently, multiple trial-and-error cycles inevitably occur to require enormous time and expense.

The present invention takes as its object the provision of an electrolytic imidazolium solution exhibiting a higher withstand voltage than electrolytes containing 1,3,4,5-tetramethylimidazolium, and an electrochemical element using the same, and additionally, an efficient production of the electrolyte.

### DISCLOSURE OF THE INVENTION

For the purpose of solving the above described problems, the present invention provides an electrolyte for electrochemical elements, the electrolyte comprising an anion component having one or more fluorine atoms and a cation component that is imidazolium or an imidazolium derivative each having one or more hydrogen atoms, and forming therein an ion associate having at least five fluorine atom/hydrogen atom pairs each having a distance of 2.7 Å or shorter between the fluorine atom in the anion component and the hydrogen atom in the cation component.

The present invention also provides a method of searching for an electrolyte for electrochemical elements, the method including the steps of: arbitrarily specifying an anion component having one or more fluorine atoms and a cation component that is imidazolium or an imidazolium derivative each having one or more hydrogen atoms; judging by simulation, on the anion and cation components thus specified, as to whether or not an ion associate is formed that has at least five fluorine atom/hydrogen atom pairs each having a distance of 2.7 Å or shorter between the fluorine atom in the anion component and the hydrogen atom in the cation component; and selecting, as solutes of the electrolyte, the anion and cation components that are judged to form the above described ion associate.

The present invention also provides a method of producing an electrolyte for electrochemical elements, the method including the steps of: arbitrarily specifying an anion component having one or more fluorine atoms and a cation component that is imidazolium or an imidazolium derivative each having one or more hydrogen atoms; judging by simulation, on the anion and cation components thus specified, as to whether or not an ion associate is formed that has at least five fluorine atom/hydrogen atom pairs each having a distance of 2.7 Å or shorter between the fluorine atom in the anion component and the hydrogen atom in the cation component; selecting, as solutes of the electrolyte, the anion and cation components that are judged to form the above described ion associate; and producing an electrolyte containing, as solutes thereof, the selected anion and cation components.

The present invention further provides an electrochemical element that uses an electrolyte which comprises an anion component having one or more fluorine atoms and a cation component that is imidazolium or an imidazolium derivative each having one or more hydrogen atoms, and forms an ion associate having at least five fluorine atom/hydrogen atom pairs each having a distance of 2.7 Å or shorter between the fluorine atom in the anion component and the hydrogen atom in the cation component.

The most prominent feature of the present invention resides in the fact that, for the purpose of increasing the withstand voltage of the electrolyte, attention is paid on the hydrogen atom/fluorine atom interatomic distances between the hydrogen atoms in the cation component and the fluorine atoms in the anion component, and accordingly these distances are made to be identified, in the case where an imidazolium cation component and an anion component containing fluorine atoms are used.

It may be assumed that in the ion associate, the fluorine atom/hydrogen atom interatomic distances between the fluorine atoms in the anion and the hydrogen atoms in the cation significantly affect the withstand voltage. The hydrogen bonds between the fluorine atoms and the hydrogen atoms having small interatomic distances have an effect to stabilize the energy of the ion associate. In this connection, it may be assumed that each of the anions and each of the cations interacting with each other in the electrolyte tend to hardly undergo redox reaction with increasing stability in the energy of the ion associate, resulting in a tendency that a high withstand voltage is attained.

Thus, there is a high possibility that the larger is the number of the hydrogen bonds formed in the ion associate, in other words, the larger is the number of the fluorine atom/hydrogen atom pairs having small interatomic distances, the higher is the withstand voltage.

Accordingly, first, those electrolytes each having an extremely high possibility of having a high withstand voltage are extracted by simulation on the basis of such a theory as described above, and the extracted electrolytes are actually prepared. The specification that the ion associate is required to have at least five fluorine atom/hydrogen atom pairs each having an interatomic distance of 2.7 Å or shorter is made to attain a higher withstand voltage than those of conventional electrolytes containing 1,3,4,5-tetramethylimidazolium. The prepared electrolytes each are checked for the withstand voltage by actual measurement. In this way, electrolytes each satisfying the desired high withstand voltage can be efficiently searched for to be produced, so that it is possible to drastically cut down the time and expense needed for developing electrolytes.

The electrochemical element of the present invention is an element using an electrolyte having a high withstand voltage, searched for and produced as described above, and is large in the energy storable per unit volume or unit weight, so that it can be suitably used as electric power source parts requiring high output power and high energy such as electric power sources to be used for driving motors in various industrial apparatuses and fuel cell vehicles. As an electric power source part for storing a certain amount of energy, the electrochemical element concerned can be downsized and light-weighted.

As the anion components to be used in the electrolyte for electrochemical elements of the present invention, preferred are PF₆⁻, BF₄⁻, AsF₆⁻, SbF₆⁻, N(RfSO₃)₂⁻, C(RfSO₃)₃⁻, RfSO₃⁻ (in these formulas, Rf represents a fluoroalkyl group having 1 to 12 carbon atoms), F⁻, AlF₄⁻, TaF₆⁻, NbF₆⁻, SiF₆⁻, and F(HF)ₙ⁻ (in this formula, n represents an integer of 1 to 4). Examples of the Rf groups contained in the anions represented by N(RfSO₃)₂⁻, C(RfSO₃)₃⁻ and RfSO₃⁻ may include a trifluoromethyl group, a pentafluoroethyl group and a heptafluoropropyl group and nonafluorobutyl group; preferred among these are a trifluoromethyl group, a pentafluoroethyl group and a heptafluoropropyl group; more preferred are a trifluoromethyl group and a pentafluoroethyl group; and particularly preferred is a trifluoromethyl group. More preferred among these anion components are PF₆⁻ (hexafluorophosphate) and BF₄⁻ (tetrafluoroborate), and particularly preferred is BF₄⁻.

Preferred as the cation components are imidazolium and imidazolium derivatives each having at least one hydrocarbon group having 1 to 20 carbon atoms which may be substituted with one or more fluorine atoms. The hydrocarbon group may be an alkyl group. Particularly preferred is 1,3-diethylimidazolium.

Examples of other preferred cation components may include imidazolium and imidazolium derivatives represented by the following formula (1): 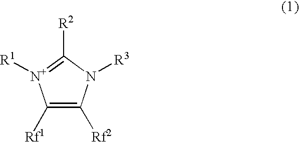
wherein R¹ and R³ are the same or different hydrocarbon groups each having 1 to 4 carbon atoms; R² is a hydrogen atom or a hydrocarbon group having 1 to 4 carbon atoms; and Rf¹ and Rf² are the same or different fluoroalkyl groups represented by CₙF₂ₙ₊₁ (n=an integer of 1 to 4) or hydrogen atoms, with the proviso that at least one of Rf¹ and Rf² is a fluoroalkyl group.

Specifically, there can be suitably used as a cation component at least one selected from the group consisting of 1-ethyl-3-methyl-4-trifluoromethylimidazolium, 1-ethyl-3-methyl-5-trifluoromethylimidazolium, 1-ethyl-3-methyl-4,5-di-trifluoromethylimidazolium, 1,3-dimethyl-4-trifluoromethylimidazolium, 1,3-dimethyl-4,5-di-trifluoromethylimidazolium, 1,3-diethyl-4-trifluoromethylimidazolium and 1,3-diethyl-4,5-di-trifluoromethylimidazolium.

A nonaqueous solvent maybe contained in the electrolyte of the present invention. As the nonaqueous solvent, those well known in the art may be used, and the nonaqueous solutions can be appropriately selected in consideration of the solubility and the electrochemical stability of the above described electrolyte salt composed of an anion component and a cation component; for example, the following solvents may be cited. The solvents may be used in combinations of two or more thereof.

Ethers: straight-chain ethers each having 4 to 12 carbon atoms (diethyl ether, methyl isopropyl ether, ethylene glycol dimethyl ether, diethylene glycol dimethyl ether, triethylene glycol diethyl ether, tetraethylene glycol diethyl ether, diethylene glycol diethyl ether, and triethylene glycol dimethyl ether and the like); and cyclic ethers each having 4 to 12 carbon atoms (tetrahydrofuran, 1,3-dioxolan, 1,4-dioxolan, 4-butyldioxolan and crown ethers (1,4,7,10,13,16-hexaoxacyclooctadecane and the like) and the like) and the like.

Amides: straight-chain amides each having 3 to 6 carbon atoms (N,N-dimethylformamide, N,N-dimethylacetamide, N,N-dimethylpropionamide, hexamethylphosphorylamide and the like), and cyclic amides each having 4 to 6 carbon atoms (pyrrolidinone, N-methylpyrrolidinone, N-vinylpyrrolidinone and the like).

Carboxylates: straight-chain esters each having 3 to 8 carbon atoms (methyl acetate, methyl propionate, dimethyl adipate and the like), and cyclic esters each having 4 or 5 carbon atoms (γ-butyrolactone, α-acetyl-γ-butyrolactone, β-butyrolactone, γ-valerolactone, σ-valerolactone and the like).

Nitriles: nitriles each having 2 to 5 carbon atoms (acetonitrile, glutaronitrile, adiponitrile, methoxyacetonitrile, 3-methoxypropionitrile, 3-ethoxypropionitrile, acrylonitrile and the like).

Carbonates: straight-chain carbonates each having 3 or 4 carbon atoms (dimethyl carbonate, ethyl methyl carbonate, diethyl carbonate and the like), and cyclic carbonates each having 3 or 4 carbon atoms (ethylene carbonate, propylene carbonate, butylene carbonate, vinylene carbonate and the like).

Sulfoxides: straight-chain sulfoxides each having 2 to 6 carbon atoms (dimethyl sulfoxide, dipropyl sulfoxide and the like) , and cyclic sulfoxides each having 4 to 6 carbon atoms (sulfolane, 3-methylsulfolane, 2,4-dimethylsulfolane and the like).

Nitro compounds: nitromethane, nitroethane and the like.

Other cyclic compounds: N-methyl-2-oxazolidinone, 3,5-dimethyl-2-oxazolidinone, 1,3-dimethyl-2-imidazolidinone and the like.

Preferred among these are carbonates, sulfoxides, carboxylates and nitriles; more preferred are carbonates, sulfoxides and nitriles; particularly preferred are ethylene carbonate, propylene carbonate and sulfolane; and most preferred are propylene carbonate and sulfolane. These nonaqueous solvents may be used as mixtures of two or more thereof; when such mixtures are used, each of the mixtures is preferably contains as the main component thereof at least one solvent selected from the group consisting of propylene carbonate, ethylene carbonate, butylene carbonate, sulfolane, methylsulfolane, acetonitrile, γ-butyrolactone, dimethyl carbonate, ethyl methyl carbonate and diethyl carbonate. Here, the phrase “contains as the main component” means that the component concerned amounts to 50 to 99 wt%, preferably 70 to 90 wt% of the mixed nonaqueous solvent concerned.

The content (wt%) of an on aqueous solvent inthe electrolyte is preferably 30 or more, more preferably 40 or more, particularly preferably 50 or more, and most preferably 60 or more, based on the weight of the electrolyte. Additionally, the content of a nonaqueous solvent is preferably 95 or less, more preferably 90 or less, particularly preferably 85 or less, and most preferably 80 or less. Within these ranges, the salt precipitation at low temperatures hardly tends to occur, and the performance degradation of an electrochemical capacitor with time can be further improved.

The water content (ppm) in the electrolyte is, from the viewpoint of the electrochemical stability, preferably 300 or less, more preferably 100 or less, and particularly preferably 50 or less, based on the volume of the electrolyte. When the water content falls within these ranges, the performance degradation of the electrochemical capacitor with time can be suppressed. The water content in the electrolyte can be measured by the Karl Fischer method (JIS K0113-1997, coulometric titration method).

Examples of the method for setting the water content in the electrolyte within the above described ranges may include a method in which an electrolyte salt sufficiently dried in advance and a nonaqueous solvent sufficiently dehydrated in advance are used.

Examples of the drying method may include a method in which a trace amount of water contained is eliminated by evaporation through drying by heating under reduced pressure (for example, heating at 150° C. under a reduced pressure of Torr).

Examples of the dehydration method may include a method in which a trace amount of water contained is eliminated by evaporation through dehydration by heating under reduced pressure (for example, heating under a pressure of 100 Torr), and a method in which a dehydrating agent such as a molecular sieve (3A1/16 or the like manufactured by Nacalai Tesque, Inc.) or activated alumina powder is used.

Examples of methods other than those cited above may include a method in which a trace amount of water contained is eliminated by evaporation through dehydration by heating the electrolyte under reduced pressure (for example, heating at 100° C. under a reduced pressure of 100 Torr), and a method in which a dehydrating agent such as a molecular sieve or activated alumina powder is used.

These methods may be applied each alone or in combinations of two or more thereof. Preferred among these methods are the method in which an electrolyte salt is dried by heating under reduced pressure and a method in which a molecular sieve is added to the electrolyte.

The concentration of an electrolyte salt in the electrolyte is preferably 0.1 mol/L or more and more preferably 0.5 mol/L or more from the viewpoints of the electric conductivity and the internal resistance of the electrolyte, and preferably 4 mol/L or less and more preferably 3 mol/L or less from the viewpoint of the precipitation of the salt at low temperatures. As far as the properties of the electrolyte are not impaired, various additives may be added thereto according to need.

The simulation for searching for and producing an electrolyte for electrochemical elements may be carried out by means of a molecular orbital calculation based on the Hartee-Fock approximation or the density functional formalism.

### BRIEF DESCRIPTION OF THE DRAWING

FIG. 1 is an external view of an electric double layer capacitor as an example of an electrochemical element in which an electrolyte of the present invention is used.

### BEST MODE FOR CARRING OUT THE INVENTION

Hereinbelow, the embodiments of the present invention will be specifically described.

### EXAMPLE 1

The structure of the ion associate (I) contained in the electrolyte for electrochemical element in Example 1 of the present invention is shown below. The structure was obtained by means of a molecular orbital calculation based on the Hartee-Fock method and a 3−21+G basis function set. The anion and cation components constituting the ion associate are tetrafluoroborate and 1,3-diethylimidazolium, respectively. The numbers attached to the elemental symbols serve to identify the atoms situated at the individual sites.

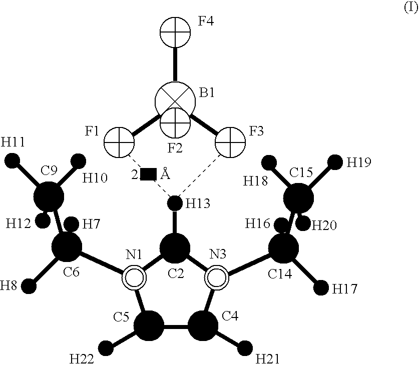

Tetrafluoroborate has a structure in which fluorine atoms F1, F2, F3 and F4 are bonded to a boron atom B1 each in a direction toward a vertex of a tetrahedron.

1,3-Diethylimidazolium has a five-membered ring in which a nitrogen atom N1, a carbon atom C2, a nitrogen atom N3, a carbon atom C4 and a carbon atom C5 are sequentially bonded in this order, and the carbon atom C5 is bonded to the nitrogen atom N1.

To the nitrogen atom N1 in the five-membered ring, a carbon atom C6 constituting a first ethyl group is bonded; to this carbon atom C6, a carbon atom C9, hydrogen atoms H7 and H8 are bonded; and to the carbon atom C9, hydrogen atoms H10, H11 and H12 are bonded.

To the nitrogen atom N3 in the five-membered ring, a carbon atom C14 constituting a second ethyl group is bonded; to this carbon atom C14, a carbon atom C15 and hydrogen atoms H16 and H17 are bonded; and to the carbon atom C15, hydrogen atoms H18, H19 and H20 are bonded.

Further, hydrogen atoms H13, H21 and H22 are bonded to the carbon atoms C2, C4 and C5 in the five-membered ring, respectively.

When an electrolyte is developed, a computer simulation is carried out according to the steps of: arbitrarily specifying the relative positions of tetrafluoroborate representing the anion component and 1,3-diethylimidazolium representing the cation component; and making a computer simulation on the basis of the thus assumed ion associate (I).

On completion of the simulation made on this ion associate (I), a selection is made to select those fluorine atom/hydrogen atom pairs each having a distance between the fluorine atom in the anion component and the hydrogen atom in the cation component of 2.7 Å or shorter; and the number of such qualified pairs is counted. If the number thus obtained is 5 or more, this combination of the anion component and the cation component is judged to be “adequate.”

In this ion associate (I), the number of the fluorine atom/hydrogen atom pairs composed of the fluorine atoms in the tetrafluoroborate anion and the hydrogen atoms in the 1,3-diethylimidazolium cation amounts to 52 to give 52 different definitions of the interatomic distances of the fluorine atom/hydrogen atom pairs. Among these pairs, the 7 pairs shown below in Table 1 each have a fluorine atom/hydrogen atom interatomic distance of 2.7 Å or shorter. Consequently, the combination of tetrafluoroborate and 1,3-diethylimidazolium is judged to be “adequate.”

TABLE 1

| Atomic | Interatomic |
|---|---|
| combination | distance (Å) |
| F1-H13 | 2.01 |
| F3-H13 | 2.01 |
| F1-H7 | 2.30 |
| F3-H16 | 2.30 |
| F2-H13 | 2.60 |
| F1-H10 | 2.67 |
| F3-H18 | 2.67 |

By using, as the solutes, tetrafluoroborate and 1,3-diethylimidazolium judged to be “adequate,” an electrolyte is produced.

In this way, an electrolyte having a desired high withstand voltage can be searched for and produced efficiently.

The structure of an ion associate (II) contained in a conventional electrolyte is shown below. The anion and cation components constituting the ion associate is tetrafluoroborate and 1,3,4,5-tetramethylimidazolium, respectively.

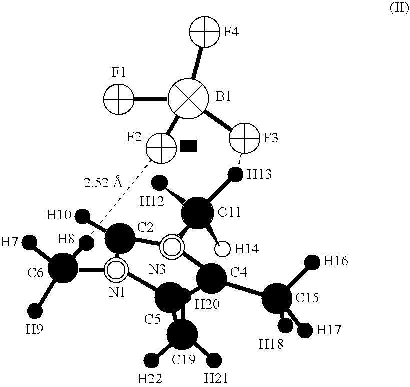

A tetrafluoroborate anion is constituted with a boron atom B1, and fluorine atoms F1, F2, F3 and F4.

In 1,3,4,5-tetramethylimidazolium, a nitrogen atom N1, a carbon atom C2, a nitrogen atom N3, and carbon atoms C4 and C5 form a five-membered ring.

To the nitrogen atom N1 in the five-membered ring, amethyl group composed of a carbon atom C6 and hydrogen atoms H7, H8 and H9 is bonded; to the carbon atom C2, a hydrogen atom H10 is bonded; to the nitrogen atom N3, a methyl group composed of a carbon atom C11 and hydrogen atoms H12, H13 and H14 is bonded; to the carbon atom C4, a methyl group composed of a carbon atom C15 and hydrogen atoms H16, H17 and H18 is bonded; and to the carbon atom C5, a methyl group composed of a carbon atom C19 and hydrogen atoms H20, H21 and H22 is bonded.

In this ion associate (II), among the fluorine atom/hydrogen atom pairs constituted with the fluorine atoms in tetrafluoroborate as the anion component and the hydrogen atoms in 1,3,4,5-tetramethylimidazolium as the cation component, the 3 pairs shown below in Table 2 each have an interatomic distance of 2.7 Å or shorter.

TABLE 2

| Atomic | Interatomic |
|---|---|
| combination | distance (Å) |
| F2-H8 | 2.52 |
| F3-H13 | 2.52 |
| F1-H10 | 2.54 |

Thus, it is predicted that the electrolyte of the present invention containing 1,3-diethylimidazolium is higher in withstand voltage than the conventional electrolyte containing 1,3,4,5-tetramethylimidazolium.

Actually, 1,3-diethylimidazolium tetrafluoroborate was synthesized and dissolved in propylene carbonate in a concentration of 0.5 mol/L to produce the electrolyte of the present invention. For comparison, 1,3,4,5-tetramethylimidazolium tetrafluoroborate was dissolved in propylene carbonate in a concentration of 0.5 mol/L to prepare the conventional electrolyte.

For each of both electrolytes thus obtained, the potential window was determined by cyclic voltammetry (scanning rate: 10 mV/sec, working electrode: glassy carbon, reference electrode: Ag⁺/Ag, counter electrode: Pt, at room temperature) over a voltage range in which the current was 10 μA/cm² or less; consequently, the electrolyte of the present invention has been found to be larger by 0.2 V in potential window than the conventional electrolyte to reveal that the withstand voltage of the electrolyte of the present invention is improved.

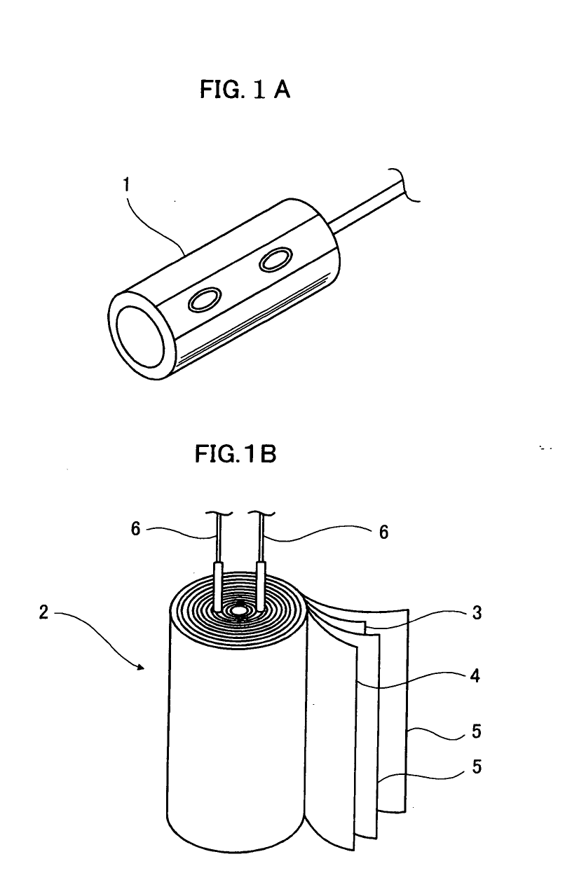

FIG. 1 shows an electric double layer capacitor as an example of an electrochemical element in which the electrolyte of the present invention is used.

The electric double layer capacitor has a commonplace structure in which an element 2 is hold inside an exterior case 1. The element 2 is constituted with an positive electrode 3 and a negative electrode 4, both made of an aluminum foil or the like, which are wound in such a way that the positive electrode and the negative electrode face each other through the intermediary of a separator made of an electrolyte paper or the like, and lead wires 6 respectively connected to the wound positive and negative electrodes 3 and 4. The positive electrode 3 and the negative electrode 4 contain activated carbon, and the electrolyte penetrates inside the pores in the activated carbon. The withstand voltage of the electric double layer capacitor is significantly dependent on the electrolyte, and it has been verified that the use of the electrolyte of the present invention drastically improves the withstand voltage.

Also, when the electrolyte of the present invention is applied to other electrochemical elements such as electrolytic condensers, high withstand voltages are attained.

### EXAMPLE 2

The structure of an ion associate (III) contained in the electrolyte for electrochemical elements in Example 2 of the present invention is shown below. The structure was obtained in the same manner as in Example 1. The anion and cation components constituting the ion associate are tetrafluoroborate and 1.3-dimethyl-4-trifluoromethylimidazolium, respectively. The numbers attached to the elemental symbols serve to identify the atoms situated at the individual sites.

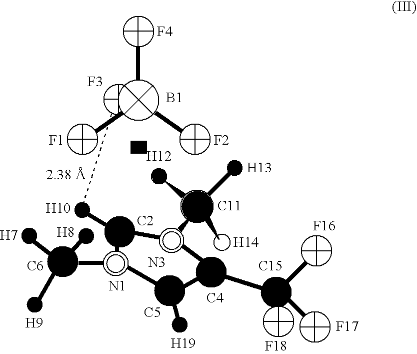

Tetrafluoroborate is constituted with a boron atom B1, and fluorine atoms F1, F2, F3 and F4.

In 1,3-dimethyl-4-trifluoromethylimidazolium, a nitrogen atom N1, a carbon atom C2, a nitrogen atom N3, and carbon atoms C4 and C5 form a five-membered ring.

To the nitrogen atom N1 in the five-membered ring, a methyl group composed of a carbon atom C6 and hydrogen atoms H7, H8 and H9 is bonded; to the carbon atom C2, a hydrogen atom H10 is bonded; to the nitrogen atom N3, a methyl group composed of a carbon atom C11 and hydrogen atoms H12, H13 and H14 is bonded; to the carbon atom C4, a trifluoromethyl group composed of a carbon atom C15 and fluorine atoms F16, F17 and F18 is bonded; and to the carbon atom C5, a hydrogen atom H19 is bonded.

In this ion associate (III), among the fluorine atom/hydrogen atom pairs constituted with the fluorine atoms in the anion component (tetrafluoroborate) and the hydrogen atoms in the cation component (1,3-dimethyl-4-trifluoromethylimidazolium), the 5 pairs shown below in Table 3 each have an interatomic distance of 2.7 Å or shorter.

TABLE 3

| Atomic | Interatomic |
|---|---|
| combination | distance (Å) |
| F3-H10 | 2.37 |
| F3-H12 | 2.60 |
| F1-H10 | 2.51 |
| F1-H8 | 2.64 |
| F1-H7 | 2.70 |

Thus, it is predicted that the electrolyte of the present invention containing 1,3-dimethyl-4-trifluoromethylimidazolium is higher in withstand voltage than the conventional electrolyte containing 1,3,4,5-tetramethylimidazolium.

Actually, 1,3-dimethyl-4-trifluoromethylimidazolium tetrafluoroborate was synthesized and dissolved in propylene carbonate in a concentration of 0.5 mol/L to produce the electrolyte of the present invention. For comparison, 1,3,4,5-tetramethylimidazolium tetrafluoroborate was dissolved in propylene carbonate in a concentration of 0.5 mol/L to prepare the conventional electrolyte.

For each of both electrolytes thus obtained, the potential window was determined by cyclic voltammetry (scanning rate: 10 mV/sec, working electrode: glassy carbon, reference electrode: Ag⁺/Ag, counter electrode: Pt, at room temperature) over a voltage range in which the current was 1 mA/cm² or less; consequently, the electrolyte of the present invention has been found to be larger by 0.9 V in potential window than the conventional electrolyte to reveal that the withstand voltage of the electrolyte of the present invention is improved.

Also, when the electrolyte of the present invention is applied to electrochemical elements such as electric double layer capacitors and electrolytic condensers, high withstand voltages are attained.

As described above, according to the present invention, the search for and production of an electrolyte having a higher withstand voltage than a conventional electrolyte containing 1,3,4,5-tetramethylimidazolium can be made efficiently in the following way: at the beginning, only those electrolytes each of which has an extremely high probability of attaining a high withstand voltage are extracted through simulation; the extracted electrolytes are actually prepared; and the withstand voltage of each of these prepared solution is checked by measurement. It is to be noted that the electrolyte of the present invention also has an electrolyte resistance as low as that exhibited by the conventional imidazolium electrolyte. Consequently, the use of the electrolyte of the present invention as an electrolyte for electrochemical elements makes it possible to actualize electrochemical elements high in energy density and suitable for electric power sources for driving motors in various industrial apparatuses and fuel cell vehicles, and the like.

1. An electrolyte for electrochemical elements, comprising an anion component having one or more fluorine atoms and a cation component that is imidazolium or an imidazolium derivative each having one or more hydrogen atoms, and forming therein an ion associate having at least five fluorine atom/hydrogen atom pairs each having a distance of 2.7 Å or shorter between the fluorine atom in the anion component and the hydrogen atom in the cation component.

2. The electrolyte for electrochemical elements according to claim 1, further comprising tetrafluoroborate as the anion component.

3. The electrolyte for electrochemical elements according to claim 1, further comprising hexafluorophosphate as the anion component.

4. The electrolyte for electrochemical elements according to claim 1, further comprising imidazolium or an imidazolium derivative each having at least one hydrocarbon group having 1 to 20 carbon atoms that may be substituted by one or more fluorine atoms.

5. The electrolyte for electrochemical elements according to claim 4, wherein the hydrocarbon group is an alkyl group.

6. The electrolyte for electrochemical elements according to claim 5, further comprising 1,3-diethylimidazolium as the cation component.

7. The electrolyte for electrochemical elements according to claim 4, further comprising, as the cation component, imidazolium or an imidazolium derivative represented by the following formula (1): 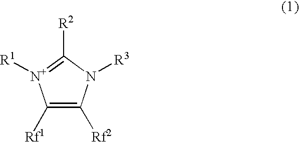
wherein R¹ and R³ are the same or different hydrocarbon groups each having 1 to 4 carbon atoms; R² is a hydrogen atom or a hydrocarbon group having 1 to 4 carbon atoms; and Rf¹ and Rf² are the same or different fluoroalkyl groups represented by CₙF₂ₙ₊₁ (n=an integer of 1 to 4) or hydrogen atoms, with the proviso that at least one of Rf¹ and Rf² is a fluoroalkyl group.

8. The electrolyte for electrochemical elements according to claim 7, further comprising as the cation component at least one selected from the group consisting of 1-ethyl-3-methyl-4-trifluoromethylimidazolium, 1-ethyl-3-methyl-5-trifluoromethylimidazolium, 1-ethyl-3-methyl-4,5-di-trifluoromethylimidazolium, 1,3-dimethyl-4-trifluoromethylimidazolium, 1,3-dimethyl-4,5-di-trifluoromethylimidazolium, 1,3-diethyl-4-trifluoromethylimidazolium, and 1,3-diethyl-4,5-di-trifluoromethylimidazolium.

9. A method of searching for an electrolyte for electrochemical elements, comprising:
arbitrarily specifying an anion component having one or more fluorine atoms and a cation component that is imidazolium or an imidazolium derivative each having one or more hydrogen atoms;
judging by simulation, on the anion and cation components thus specified, as to whether or not an ion associate is formed that has at least five fluorine atom/hydrogen atom pairs each having a distance of 2.7 Å or shorter between the fluorine atom in the anion component and the hydrogen atom in the cation component; and
selecting, as solutes of the electrolyte, the anion and cation components that are judged to form the ion associate.

10. The method of sea rching for an electrolyte for electrochemical elements according to claim 9, wherein the simulation is carried out by means of a molecular orbital calculation based on the Hartee-Fock approximation or density functional formalism.

11. A method of producing an electrolyte for electrochemical elements, comprising:
arbitrarily specifying an anion component having one or more fluorine atoms and a cation component that is imidazolium or an imidazolium derivative each having one or more hydrogen atoms;
judging by simulation, on the anion and cation components thus specified, as to whether or not an ion associate is formed that has at least five fluorine atom/hydrogen atom pairs each having a distance of 2.7 Å or shorter between the fluorine atom in the anion component and the hydrogen atom in the cation component;
selecting, as solutes of the electrolyte, the anion and cation components that are judged to form the ion associate; and
producing an electrolyte containing, as solutes thereof, the selected anion and cation components.

12. The method of producing an electrolyte for electrochemical elements according to claim 11, wherein the simulation is carried out by means of a molecular orbital calculation based on the Hartee-Fock approximation or the density functional formalism.

13. An electrochemical element using an electrolyte for electrochemical elements, said electrolyte comprising an anion component having one or more fluorine atoms and a cation component that is imidazolium or an imidazolium derivative each having one or more hydrogen atoms, and forming therein an ion associate having at least five fluorine atom/hydrogen atom pairs each having a distance of 2.7 Å or shorter between the fluorine atom in the anion component and the hydrogen atom in the cation component.
